(19) United States
(12) Patent Application Publication
(10) Pub. No.: US 2009/0100077 A1
(43) Pub. Date: Apr. 16, 2009

(54) NETWORK RISK ANALYSIS METHOD USING INFORMATION HIERARCHY STRUCTURE

(76) Inventors: Tae-In Jung, Seoul (KR); Won-Tae Sim, Seongnam-si (KR); Woo-Han Kim, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/941,135

(22) Filed: Nov. 16, 2007

(30) Foreign Application Priority Data
Oct. 12, 2007 (KR) 10-2007-0102866

(51) Int. Cl. G06F 17/30

(52) U.S. Cl. 707/100; 707/E17.009

(57) ABSTRACT

A network risk analysis method using an information hierarchy structure is divided into 7 steps and results derived from each of the process steps are stored in a database to get a hierarchy structure for the respective steps. By using the information hierarchy structure, a network manager can easily comprehend the relationship between the derived results from each step to make a risk analysis in an efficient manner.

### TECHNICAL FIELD

The present invention relates to a network risk analysis method using an information hierarchy structure. According to the present invention, the network risk analysis process is divided into 7 steps and results derived from each of the process steps are stored in a database to get a hierarchy structure for the respective steps. By using the information hierarchy structure, a network manager can easily comprehend the relationship between the derived results from each step to make a risk analysis in an efficient manner.

### BACKGROUND ART

In network management, it is important to discover viruses, worms, hacker attacks, etc., early and fix them, but basically it is more effective to prevent them. For such prevention, analyzing a network risk is crucial and it includes identifying network assets to be protected, analyzing network threats and risks, and analyzing overall or aggregate risk.

OCTAVE is a risk analysis methodology developed at CMU/SEI. It is structured for performing a network asset-based evaluation and deals with each of the process steps in detail for helping staff members of an organization to be able to evaluate and manage information protection risks of their organization. OCTAVE is normally broken down into three steps, i.e., building asset-based threat profiles, identifying infrastructure vulnerabilities, and developing security strategy and plans. Table 1 below shows results from each step. OCTAVE is advantageous for a systematic analysis of risks, but it has a drawback in that at least 2-3 weeks are spent to conduct the analysis. Besides, an vast amount of analysis results from each step makes it difficult to comprehend the relationship between the results.

TABLE 1

| Process step | Result |
|---|---|
| Building asset-based threat | critical assets |
| profiles | security requirements for critical assets |
| | threats to critical assets |
| | current security practices |
| | current organizational vulnerabilities |
| Identifying infrastructure | key components |
| vulnerabilities | technology vulnerabilities |
| Developing security strategy and | risks to critical assets |
| plans | risk measures |
| | protection strategy |
| | risk mitigation plans |

Meanwhile, SP 800-30 developed at NIST is a risk management guide for information technology systems and conducts a risk analysis through nine steps, which consist of system characterization, threat identification, vulnerability identification, control analysis, likelihood determination, impact analysis, risk determination, control recommendations and results documentation. For the risk analysis, SP 800-30 collects information by using surveys, interviews, document reviews, automated tools, etc. Unfortunately, NIST SP 800-30 takes quite a long time to conduct the analysis, and a vast amount of the analysis results does not help a network manager to easily make the best use of them.

Therefore, although conventional risk analysis methodologies can specify information to be collected in each process and document format of the results, a network manager still expresses difficulties to comprehend the relationship between results and manage risk levels.

### DISCLOSURE

### Technical Problem

It is, therefore, an object of the present invention to provide a network risk analysis method composed of a 7-step process, wherein results derived from each step are stored in a database to get a hierarchy structure for the respective steps so that a network manager can easily comprehend the relationship between the derived results from each step.

Another object of the present invention is to provide a database for storing results that are generated by the analysis method described above.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a network risk analysis method using an information hierarchy structure, the method including the steps of: (a) storing information on a network environment as a target of a risk analysis, in a 1^{st} layer of a database; b) storing an active discovery result on the network in a 2^{nd} layer of the database; c) storing a passive discovery result on the network in a 3^{rd} layer of the database; d) storing a network vulnerability result obtained by using a vulnerability checking tool in a 4^{th} layer of the database; e) storing an asset analysis result and an expected attack path on the network in a 5^{th} layer of the database; f) storing a risk analysis result of the network in a 6^{th} layer of the database; and g) storing a security countermeasure for the network in a 7^{th} layer of the database.

Another aspect of the present invention provides a database including: a 1^{st} layer storing information on a network environment as a target of a risk analysis; a 2^{nd} layer storing an active discovery result on the network; a 3^{rd} layer storing a passive discovery result on the network; a 4^{th} layer storing a network vulnerability result obtained by using a vulnerability checking tool; a 5^{th} layer storing an asset analysis result and an expected attack path on the network; a 6^{th} layer storing a risk analysis result of the network; and a 7^{th} layer storing a security countermeasure for the network.

### Advantageous Effects

According to the present invention, network risk analysis results are stored in a database to get a hierarchy structure for each step of the analysis process, so that a network manager can easily comprehend the relationship between the results derived from the respective steps of the analysis process to make the risk analysis in an efficient manner.

### BRIEF DESCRIPTION OF THE DRAWINGS

FIG. 1 illustrates a hierarchy structure of results derived from each step of a network risk analysis process of the present invention.

FIG. 2 is a flow chart describing a process for selecting a security countermeasure according to a network risk analysis method of the present invention.

FIG. 3 illustrates a network security map to which an information hierarchy structure according to the present invention is applied.

FIG. 4 illustrates a traditional database used for a network risk analysis.

FIG. 5 illustrates a database using an information hierarchy structure according to the present invention.

FIG. 6 is a flow chart describing a network risk analysis process according to one embodiment of the present invention.

### BEST MODE FOR THE INVENTION

The advantages, features and aspects of the invention will become apparent from the following description of the embodiments with reference to the accompanying drawings, which is set forth hereinafter.

A network risk analysis process is largely composed of assets identification, threat analysis, vulnerability analysis, and risk level estimation. Results generated from the respective steps are correlated to each other. That is to say, if an asset to be protected has no server using a Linux operating system, its risk level will be zero even if a virus or a worm that abuses this situation or vulnerability may be discovered. Therefore, taking such a correlational relationship into account, the present invention is to provide a method for conducting a risk analysis in an efficient manner.

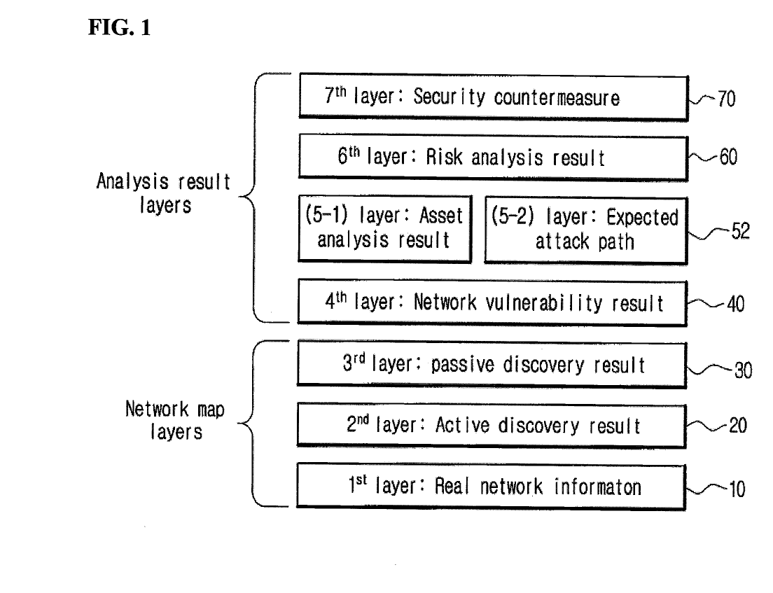

FIG. 1 illustrates a hierarchy structure of results derived from each step of a network risk analysis process of the present invention. The network risk analysis process according to the present invention consists of seven steps, so results of the risk analysis form seven layers accordingly.

As depicted in FIG. 1, results of the network risk analysis are categorized into network map layers, each being established by collecting information on a network; and analysis result layers, each displaying risk analysis results. The network map layers are composed of three specific layers, namely, a real network information (1^{st} layer) 10, an active discovery result (2^{nd} layer) 20, and a passive discovery result (3^{rd} layer) 30. The analysis result layers are composed of four specific layers, namely, a network vulnerability result (4^{th} layer) 40, an asset analysis result and expected attack path (5^{th} layer) 51 and 52, a risk analysis result (6^{th} layer) 60, and a security countermeasure (7^{th} layer) 70.

The network map layers distinguishably display a network structure that is actually perceived by a network manager and a network structure realized through network scanning or a traffic analysis. Meanwhile, the analysis result layers provide results of a risk analysis that is conducted based on the network map layers.

The following will explain in detail about each of the specific layers that constitute the network map layers and the analysis result layers.

Real network information corresponding to the 1^{st} layer is information on a real network environment perceived by a network manager. For example, node information, OS information, and application information correspond to the real network information. Such network information is very crucial for estimating a value of the assets in the 5^{th} layer, and it is either inputted by a network manager or extracted from an OS or application.

Active network discovery result corresponding to the 2^{nd} layer can be obtained by transmitting a discovery packet to a network by using a network security tool such as NMAP (Network Mapper) and analyzing a response packet received from the network as an ack. The active discovery result includes information like IP address, MAC address, OS name and version, currently open protocol/port number, etc.

Passive discovery result corresponding to the 3^{rd} layer can be obtained by monitoring, with the aid of a sniffer, traffic data being transmitted/received via a network. The passive discovery result includes information like IP address/protocol/port number of a source, IP address/protocol/port number of destination, bandwidth, bits per second (bps), packets per second (pps), etc.

Network vulnerability result corresponding to the 4^{th} layer can be obtained by utilizing a vulnerability checking tool such as Nessus. The network vulnerability result includes vulnerability name, reference ID, vulnerability description, vulnerable application information, etc.

Asset analysis result (the 5-1 layer) and expected attack path (the 5-2 layer) constitute the 5^{th} layer. The asset analysis result determines the scope and kind of an asset as a target of the risk analysis, and it includes information on asset value taking into account confidentiality, integrity, and availability of an asset. On the other hand, the expected attack path determines a path expected to get an attack based on the information from the network map layers and the asset analysis result, and it includes the shortest attack path or the most effective attack path (this is an attack path going by way of the most vulnerable system) or the like.

Risk analysis result corresponding to the 6^{th} layer expresses a risk level that is estimated on the basis of information on asset value, threat, vulnerability, etc., and it includes risk level of each application or risk level of each system. It is possible to calculate a more quantitative risk level by utilizing CVSS (Common Vulnerability Scoring System), the standard vulnerability score, and information on an asset value.

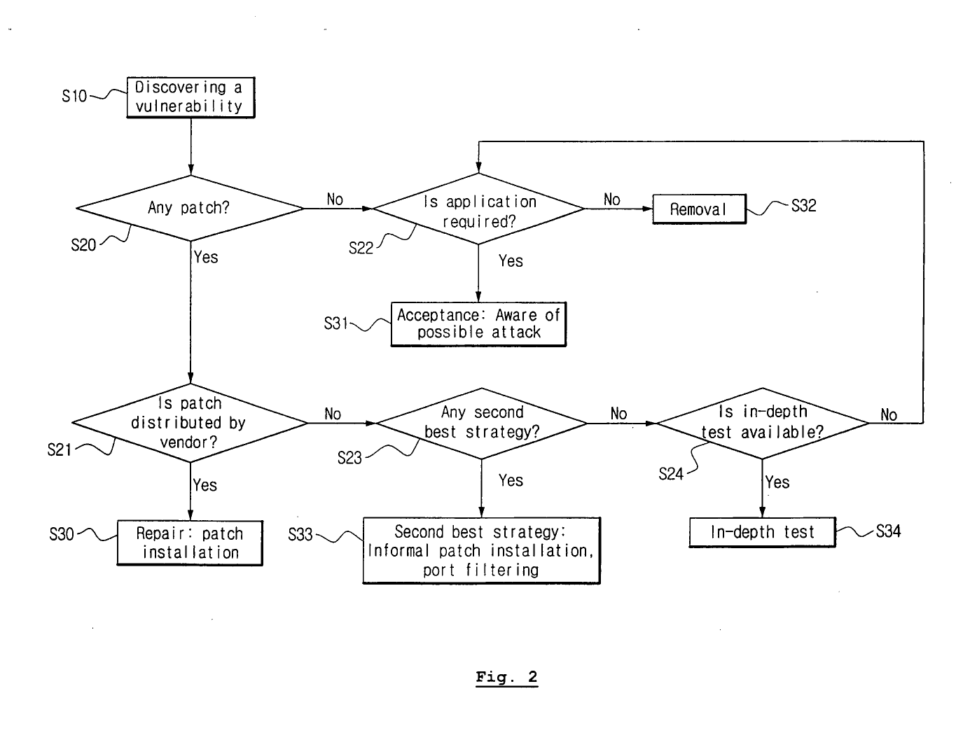

Security countermeasure corresponding to the 7^{th} level provides a possible countermeasure for each vulnerability being discovered, and it includes information on the kind, name, and description of a countermeasure. FIG. 2 is a flow chart describing a process for selecting a security countermeasure according to a network risk analysis method of the present invention. As shown in FIG. 2, a network manager finds out the existence of a patch (S20), the credibility of the patch (S21), the necessity of an application (S22), the existence of a second best strategy (S23) and whether an in-depth test is available (S24), to thus select a security countermeasure such as repair (S30), acceptance (S31), removal (S32), a second best strategy (S33), and an in-depth test (S34) for application.

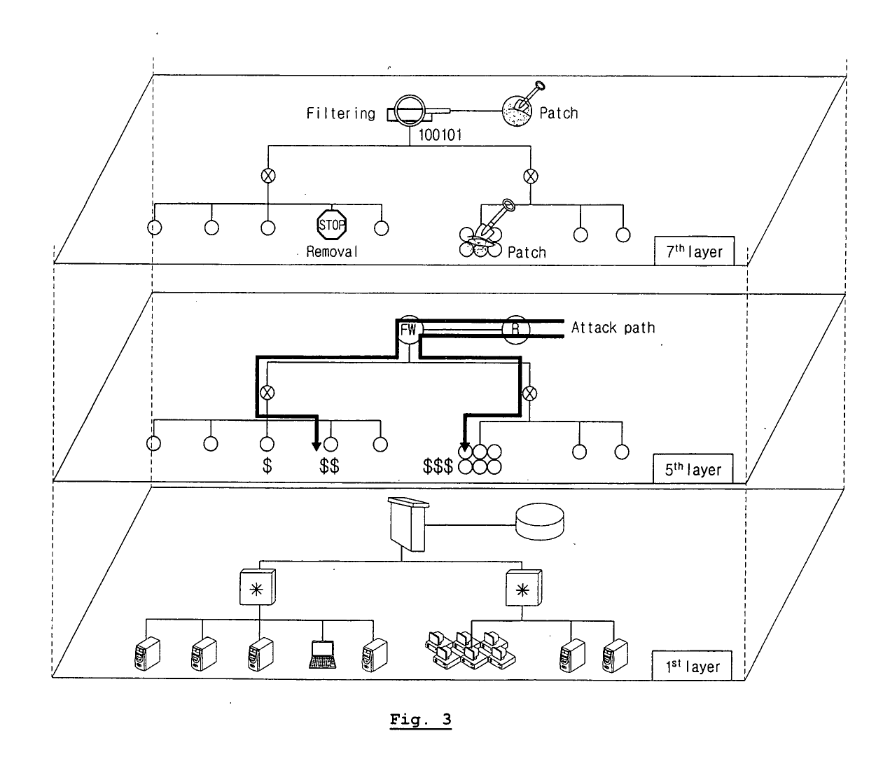

FIG. 3 illustrates a network security map to which an information hierarchy structure according to the present invention is applied, in which a management target network is distinguished by layer. For instance, the 1^{st} layer displays node information on a real network. The 5^{th} layer displays the value of an asset and an expected attack path. The 7^{th} layer displays which security countermeasure is required (the 2^{nd} through 6^{th} layers are omitted in the interest of brevity of presentation).

Optionally, information from each layer can be combined and overlapped in one network security map. In this case, a network manager can see major nodes of a network, vulnerabilities, asset value, an attack path, and a security countermeasure at one view so that he may be able to immediately, intuitively comprehend the relationship between results from the respective steps and conduct a network risk analysis more efficiently.

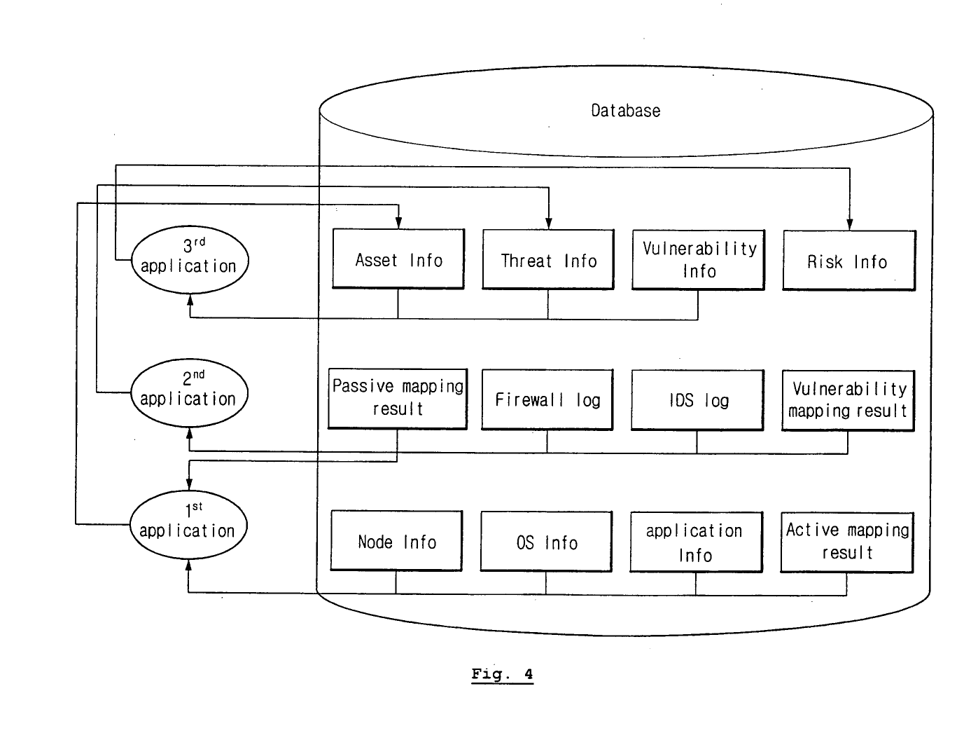

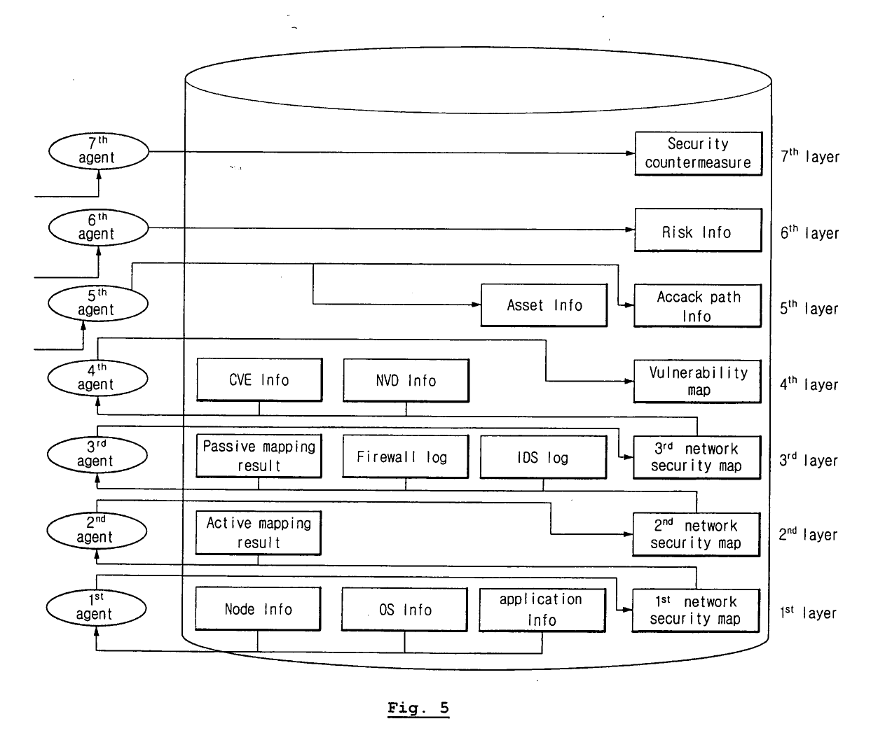

The following will now explain a database to practice the information hierarchy structure of the present invention, in reference to FIGS. 4 and 5.

FIG. 4 illustrates a traditional database used for a network risk analysis, and FIG. 5 illustrates a database using an information hierarchy structure according to the present invention.

In the traditional database, data tables containing collected, analyzed results from a risk analysis process were stored in a planar structure. This structure was difficult for a network manager to intuitively perceive the relationships between tables. Moreover, as data were generated by applications, it took much time and effort to add or modify an application.

On the contrary, the database according to the present invention adopts an information hierarchy structure as discussed earlier. According to the present invention, each layer of the hierarchy structure corresponds to a data table with information collected from each step of a risk analysis.

Referring to FIG. 5, the 1^{st} layer of the database stores the node, OS, and application information inputted by a network manager and a 1^{st} network security map composed based on these information. The 2^{nd} layer of the database stores an active mapping result as a result of the active discovery result and a 2^{nd} network security map composed based on the active mapping result and the information from the 1^{st} layer. The 3^{rd} layer of the database stores a passive mapping result as a result of the passive discovery result, firewall and IDS (Intrusion Detection System) log information, and a 3^{rd} network security map composed based on these information and the information from the 2^{nd} layer.

Meanwhile, the 4^{th} through 7^{th} layers store results that are collected/generated in corresponding steps of a risk analysis process based on the information stored in the network map layers (i.e., the 1^{st} through 3^{rd} layers).

As can be seen from the above description, there is a direction between the respective layers so data is generated only in a direction from lower layers towards higher layers. That is, although a higher layer may be able to generate required data by using data of lower layers, a lower layer cannot generate new data by using data of higher layers. In addition, each of the layers in the database has an agent that retrieves data from the database and generates new data out of it.

The agent of each layer can be defined as follows:

Aᵢ(1≦i≦7, i is an integer): A set of agents in charge of data of the (i)-th layer;

Aᵢⱼ(1≦i and j≦7, j≦i): An agent generating data for the (i)-th layer by using data of the (j)-th layer.

For instance, the 1^{st} agent (A₁) outputs node information based on the required data having received from a network manager and stores it in the database. On the other hand, the 2^{nd} agent (A₂) consists of an agent (A₂₁) generating data by using the data of the 1^{st} layer and an agent (A₂₂) actively discovering a network. With these definitions, input/output data layers of agents are explicitly described to clarify the relationship between data.

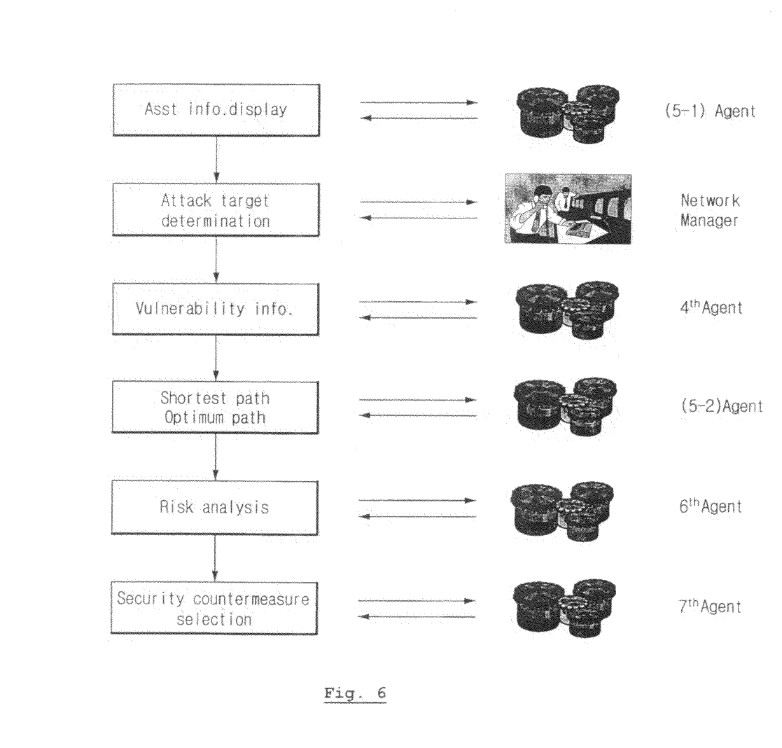

FIG. 6 is a flow chart describing a network risk analysis process according to one embodiment of the present invention. First of all, a critical path, which is a set of essential nodes for providing a service with a high level of significance, is determined by using asset analysis results (the (5-1) layer). After that, an attack path, which is a set of nodes where damages are spread due to a virus or worm outbreak abusing a specific vulnerability, is expected. Through this, a network manager estimates a damage level and can suggest preventative measures in order of priority in order to protect major nodes and the critical path.

Once vulnerability, asset values, attack path, risk levels of all nodes existing in a target network are known, it becomes possible to forecast an infection and transmission path by a specific virus or worm and expected damages. In addition, the risk analysis method of the present invention can help a network manager decide the priority of security countermeasures.

According to the present invention, results derived from each of the network risk analysis process steps are stored in a database to get a hierarchy structure for the respective steps, so that a network manager can easily comprehend the relationship between the derived results from each step to make a risk analysis in an efficient manner based on the information hierarchy structure.

While the present invention has been described with respect to certain preferred embodiments, it will be apparent to those skilled in the art that various changes and modifications may be made without departing from the scope of the invention as defined in the following claims

What is claimed is:

1. A network risk analysis method, comprising the steps of:
a) storing information on a network environment as a target of a risk analysis, in a 1^{st} layer of a database;
b) storing an active discovery result on the network in a 2^{nd} layer of the database;
c) storing a passive discovery result on the network in a 3^{rd} layer of the database;
d) storing a network vulnerability result obtained by using a vulnerability checking tool in a 4^{th} layer of the database;
e) storing an asset analysis result and an expected attack path on the network in a 5^{th} layer of the database;
f) storing a risk analysis result of the network in a 6^{th} layer of the database; and
g) storing a security countermeasure for the network in a 7^{th} layer of the database.

2. The method according to claim 1, wherein the information on the network environment comprises information on nodes included in the network, OS information, and application information.

3. The method according to claim 1, wherein the active discovery result is obtained by transmitting a discovery packet to a network by using a network security tool and analyzing a response packet received from the network.

4. The method according to claim 1, wherein the passive discovery result is obtained by monitoring traffic data transmitted/received via a network, with the aid of a sniffer.

5. The method according to claim 1, wherein the asset analysis result comprises information on asset value taking into account confidentiality, integrity and availability of an asset.

6. The method according to claim 1, wherein the risk analysis result comprises a risk level that is estimated on the basis of information on asset value, threat, and vulnerability.

7. The method according to claim 1, wherein the security countermeasure comprises information on a kind, name, and description of a countermeasure that is selected taking into account the existence of a patch, the credibility of the patch, the necessity of an application, the existence of a second best strategy and whether an in-depth test is available.

8. A database comprising:
a 1^{st} layer storing information on a network environment as a target of a risk analysis;
a 2^{nd} layer storing an active discovery result on the network;
a 3^{rd} layer storing a passive discovery result on the network;
a 4^{th} layer storing a network vulnerability result obtained by using a vulnerability checking tool;
a 5^{th} layer storing an asset analysis result and an expected attack path on the network;
a 6^{th} layer storing a risk analysis result of the network; and
a 7^{th} layer storing a security countermeasure for the network.

9. The database according to claim 8, wherein the 3^{rd} layer further stores a firewall and IDS (Intrusion Detection System) log information.

10. The database according to claim 8, wherein each of the layers in the database has an agent that generates new data by using the data retrieved from the lower layers of the database.
